(19) United States
(12) Patent Application Publication
(10) Pub. No.: US 2026/0164045 A1
(43) Pub. Date: Jun. 11, 2026

(54) METHOD, APPARATUS, AND MEDIUM FOR VISUAL DATA PROCESSING

(71) Applicants: Douyin Vision Co., Ltd., Beijing (CN); Bytedance Inc., Los Angeles, CA (US)

(72) Inventors: Semih ESENLIK, Los Angeles, CA (US); Zhaobin ZHANG, Los Angeles, CA (US); Yaojun WU, Beijing (CN); Meng WANG, Beijing (CN); Kai ZHANG, Los Angeles, CA (US); Li ZHANG, Los Angeles, CA (US)

(21) Appl. No.: 19/185,112

(22) Filed: Apr. 21, 2025

Related U.S. Application Data
(63) Continuation of application No. PCT/CN2023/125503, filed on Oct. 19, 2023.

(30) Foreign Application Priority Data
Oct. 21, 2022 (WO) PCT/CN2022/126673

(51) Int. Cl. H04N 19/189; H04N 19/136

(52) U.S. Cl. CPC H04N 19/189; H04N 19/136

(57) ABSTRACT

Embodiments of the present disclosure provide a solution for visual data processing. A method for visual data processing is proposed. The method comprises: performing a conversion between visual data and a bitstream of the visual data with a neural network (NN)-based model, wherein the bitstream comprises a first indication indicating whether a set of values for a set of parameters for the NN-based model is common to processing of a plurality of components of the visual data.

### CROSS REFERENCE TO RELATED APPLICATIONS

This application is a continuation of International Application No. PCT/CN2023/125503, filed on Oct. 19, 2023, which claims the benefit of International Application No. PCT/CN2022/126673, filed on Oct. 21, 2022. The entire contents of these applications are hereby incorporated by reference in their entireties.

### FIELDS

Embodiments of the present disclosure relates generally to visual data processing techniques, and more particularly, to neural network-based visual data coding.

### BACKGROUND

The past decade has witnessed the rapid development of deep learning in a variety of areas, especially in computer vision and image processing. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable rate-distortion (R-D) performance with Versatile Video Coding (VVC). With the performance of neural image compression continually being improved, neural network-based video compression has become an actively developing research area. However, coding quality and coding efficiency of neural network-based image/video coding is generally expected to be further improved.

### SUMMARY

Embodiments of the present disclosure provide a solution for visual data processing.

In a first aspect, a method for visual data processing is proposed. The method comprises: performing a conversion between visual data and a bitstream of the visual data with a neural network (NN)-based model, wherein the bitstream comprises a first indication indicating whether a set of values for a set of parameters for the NN-based model is common to processing of a plurality of components of the visual data.

According to the method in accordance with the first aspect of the present disclosure, an indication is comprised in the bitstream and indicates whether a set of values for a set of parameters for the NN-based model is common to processing of a plurality of components of the visual data. In aid of this indication, it is possible to avoid signaling the set of values separately for the plurality of components of the visual data. Thereby, the proposed method can advantageously improve coding efficiency.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of visual data which is generated by a method performed by an apparatus for visual data processing. The method comprises: performing a conversion between the visual data and the bitstream with a neural network (NN)-based model, wherein the bitstream comprises a first indication indicating whether a set of values for a set of parameters for the NN-based model is common to processing of a plurality of components of the visual data.

In a fifth aspect, a method for storing a bitstream of visual data is proposed. The method comprises: performing a conversion between the visual data and the bitstream with a neural network (NN)-based model, wherein the bitstream comprises a first indication indicating whether a set of values for a set of parameters for the NN-based model is common to processing of a plurality of components of the visual data; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example visual data coding system, in accordance with some embodiments of the present disclosure;

FIG. 2 illustrates a typical transform coding scheme;

FIG. 3 illustrates an image from the Kodak dataset and different representations of the image;

FIG. 4 illustrates a network architecture of an autoencoder implementing the hyperprior model;

FIG. 5 illustrates a block diagram of a combined model;

FIG. 6 illustrates an encoding process of the combined model;

FIG. 7 illustrates a decoding process of the combined model;

FIG. 8 illustrates an example of decoding process according to some embodiments of the present disclosure;

FIG. 9 illustrates a flowchart of a method for visual data processing in accordance with embodiments of the present disclosure; and

FIG. 10 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment.

Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

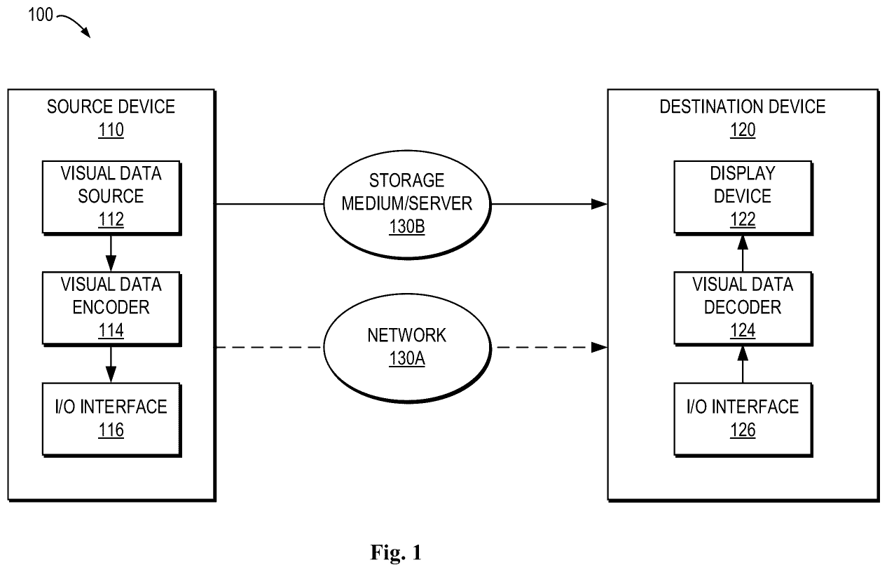

FIG. 1 is a block diagram that illustrates an example visual data coding system 100 that may utilize the techniques of this disclosure. As shown, the visual data coding system 100 may include a source device 110 and a destination device 120. The source device 110 can be also referred to as a visual data encoding device, and the destination device 120 can be also referred to as a visual data decoding device.

In operation, the source device 110 can be configured to generate encoded visual data and the destination device 120 can be configured to decode the encoded visual data generated by the source device 110. The source device 110 may include a visual data source 112, a visual data encoder 114, and an input/output (I/O) interface 116.

The visual data source 112 may include a source such as a visual data capture device. Examples of the visual data capture device include, but are not limited to, an interface to receive visual data from a visual data provider, a computer graphics system for generating visual data, and/or a combination thereof.

The visual data may comprise one or more pictures of a video or one or more images. The visual data encoder 114 encodes the visual data from the visual data source 112 to generate a bitstream. The bitstream may include a sequence of bits that form a coded representation of the visual data. The bitstream may include coded pictures and associated visual data. The coded picture is a coded representation of a picture. The associated visual data may include sequence parameter sets, picture parameter sets, and other syntax structures. The I/O interface 116 may include a modulator/demodulator and/or a transmitter. The encoded visual data may be transmitted directly to destination device 120 via the I/O interface 116 through the network 130A. The encoded visual data may also be stored onto a storage medium/server 130B for access by destination device 120.

The destination device 120 may include an I/O interface 126, a visual data decoder 124, and a display device 122. The I/O interface 126 may include a receiver and/or a modem. The I/O interface 126 may acquire encoded visual data from the source device 110 or the storage medium/server 130B.

The visual data decoder 124 may decode the encoded visual data. The display device 122 may display the decoded visual data to a user. The display device 122 may be integrated with the destination device 120, or may be external to the destination device 120 which is configured to interface with an external display device.

The visual data encoder 114 and the visual data decoder 124 may operate according to a visual data coding standard, such as video coding standard or still picture coding standard and other current and/or further standards.

Some exemplary embodiments of the present disclosure will be described in detailed hereinafter.

It should be understood that section headings are used in the present document to facilitate ease of understanding and do not limit the embodiments disclosed in a section to only that section. Furthermore, while certain embodiments are described with reference to Versatile Video Coding or other specific visual data codecs, the disclosed techniques are applicable to other coding technologies also.

Furthermore, while some embodiments describe coding steps in detail, it will be understood that corresponding steps decoding that undo the coding will be implemented by a decoder. Furthermore, the term visual data processing encompasses visual data coding or compression, visual data decoding or decompression and visual data transcoding in which visual data are represented from one compressed format into another compressed format or at a different compressed bitrate.

### 1. BRIEF SUMMARY

A neural network-based image and video compression method comprising separate processing of color components of an image, wherein control parameters used for processing of one component is used also for the other component.

### 2. INTRODUCTION

The past decade has witnessed the rapid development of deep learning in a variety of areas, especially in computer vision and image processing. Inspired from the great success of deep learning technology to computer vision areas, many researchers have shifted their attention from conventional image/video compression techniques to neural image/video compression technologies. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable R-D performance with Versatile Video Coding (VVC), the latest video coding standard developed by Joint Video Experts Team (JVET) with experts from MPEG and VCEG. With the performance of neural image compression continually being improved, neural network-based video compression has become an actively developing research area. However, neural network-based video coding still remains in its infancy due to the inherent difficulty of the problem.

### 2.1. Image/Video Compression

Image/video compression usually refers to the computing technology that compresses image/video into binary code to facilitate storage and transmission. The binary codes may or may not support losslessly reconstructing the original image/video, termed lossless compression and lossy compression. Most of the efforts are devoted to lossy compression since lossless reconstruction is not necessary in most scenarios. Usually the performance of image/video compression algorithms is evaluated from two aspects, i.e. compression ratio and reconstruction quality. Compression ratio is directly related to the number of binary codes, the less the better; Reconstruction quality is measured by comparing the reconstructed image/video with the original image/video, the higher the better.

Image/video compression techniques can be divided into two branches, the classical video coding methods and the neural-network-based video compression methods. Classical video coding schemes adopt transform-based solutions, in which researchers have exploited statistical dependency in the latent variables (e.g., DCT or wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs.

In the last three decades, a series of classical video coding standards have been developed to accommodate the increasing visual content. The international standardization organizations ISO/IEC has two expert groups namely Joint Photographic Experts Group (JPEG) and Moving Picture Experts Group (MPEG), and ITU-T also has its own Video Coding Experts Group (VCEG) which is for standardization of image/video coding technology. The influential video coding standards published by these organizations include JPEG, JPEG 2000, H.262, H.264/AVC and H.265/HEVC. After H.265/HEVC, the Joint Video Experts Team (JVET) formed by MPEG and VCEG has been working on a new video coding standard Versatile Video Coding (VVC). The first version of VVC was released in July 2020. An average of 50% bitrate reduction is reported by VVC under the same visual quality compared with HEVC.

Neural network-based image/video compression is not a new invention since there were a number of researchers working on neural network-based image coding. But the network architectures were relatively shallow, and the performance was not satisfactory. Benefit from the abundance of data and the support of powerful computing resources, neural network-based methods are better exploited in a variety of applications. At present, neural network-based image/video compression has shown promising improvements, confirmed its feasibility. Nevertheless, this technology is still far from mature and a lot of challenges need to be addressed.

### 2.2. Neural Networks

Neural networks, also known as artificial neural networks (ANN), are the computational models used in machine learning technology which are usually composed of multiple processing layers and each layer is composed of multiple simple but non-linear basic computational units. One benefit of such deep networks is believed to be the capacity for processing data with multiple levels of abstraction and converting data into different kinds of representations. Note that these representations are not manually designed; instead, the deep network including the processing layers is learned from massive data using a general machine learning procedure. Deep learning eliminates the necessity of handcrafted representations, and thus is regarded useful especially for processing natively unstructured data, such as acoustic and visual signal, whilst processing such data has been a longstanding difficulty in the artificial intelligence field.

### 2.3. Neural Networks for Image Compression

Existing neural networks for image compression methods can be classified in two categories, i.e., pixel probability modeling and auto-encoder. The former one belongs to the predictive coding strategy, while the latter one is the transform-based solution. Sometimes, these two methods are combined together in literature.

### 2.3.1. Pixel Probability Modeling

According to Shannon's information theory, the optimal method for lossless coding can reach the minimal coding rate −log₂ p(x) where p(x) is the probability of symbol x. A number of lossless coding methods were developed in literature and among them arithmetic coding is believed to be among the optimal ones. Given a probability distribution p(x), arithmetic coding ensures that the coding rate to be as close as possible to its theoretical limit −log₂ p(x) without considering the rounding error. Therefore, the remaining problem is to how to determine the probability, which is however very challenging for natural image/video due to the curse of dimensionality.

Following the predictive coding strategy, one way to model p(x) is to predict pixel probabilities one by one in a raster scan order based on previous observations, where x is an image.

$$p ( x ) = p ( {x}_{1} ) p ( {x}_{2} \vert {x}_{1} ) … p ( {x}_{i} \vert {x}_{1} , … , {x}_{i - 1} ) … p ( {x}_{m \times n} \vert {x}_{1} , … , {x}_{m \times n - 1} ) \qquad ( 1 )$$

where m and n are the height and width of the image, respectively. The previous observation is also known as the context of the current pixel. When the image is large, it can be difficult to estimate the conditional probability, thereby a simplified method is to limit the range of its context.

$$p ( x ) = p ( {x}_{1} ) p ( {x}_{2} \vert {x}_{1} ) … p ( {x}_{i} \vert {x}_{i - k} , … , {x}_{i - 1} ) … p ( {x}_{m \times n} \vert {x}_{m \times n - k} , … , {x}_{m \times n - 1} ) \qquad ( 2 )$$

where k is a pre-defined constant controlling the range of the context.

It should be noted that the condition may also take the sample values of other color components into consideration. For example, when coding the RGB color component, R sample is dependent on previously coded pixels (including RIG/B samples), the current G sample may be coded according to previously coded pixels and the current R sample, while for coding the current B sample, the previously coded pixels and the current R and G samples may also be taken into consideration.

Neural networks were originally introduced for computer vision tasks and have been proven to be effective in regression and classification problems. Therefore, it has been proposed using neural networks to estimate the probability of p(xᵢ) given its context x₁, x₂, . . . , xᵢ₋₁. In an existing design, the pixel probability is proposed for binary images, i.e., xᵢ∈{−1,+1}. The neural autoregressive distribution estimator (NADE) is designed for pixel probability modeling, where is a feed-forward network with a single hidden layer. A similar work is presented in an existing design, where the feed-forward network also has connections skipping the hidden layer, and the parameters are also shared. Experiments are performed on the binarized MNIST dataset. In an existing design, NADE is extended to a real-valued model RNADE, where the probability p(xᵢ|x₁, . . . , xᵢ₋₁) is derived with a mixture of Gaussians. Their feed-forward network also has a single hidden layer, but the hidden layer is with rescaling to avoid saturation and uses rectified linear unit (ReLU) instead of sigmoid. In an existing design, NADE and RNADE are improved by using reorganizing the order of the pixels and with deeper neural networks. Most of the above methods directly model the probability distribution in the pixel domain. Some researchers also attempt to model the probability distribution as a conditional one upon explicit or latent representations. That being said, it may be estimated that:

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h)p(x|h), meaning the modeling is split into an unconditional one and a conditional one. The additional condition can be image label information or high-level representations.

### 2.3.2. Auto-Encoder

Auto-encoder originates from an existing design. The method is trained for dimensionality reduction and consists of two parts: encoding and decoding. The encoding part converts the high-dimension input signal to low-dimension representations, typically with reduced spatial size but a greater number of channels. The decoding part attempts to recover the high-dimension input from the low-dimension representation. Auto-encoder enables automated learning of representations and eliminates the need of hand-crafted features, which is also believed to be one of the most important advantages of neural networks.

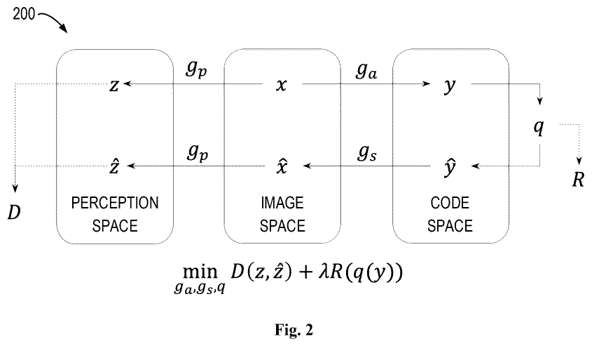

FIG. 2 illustrates a typical transform coding scheme. The original image x is transformed by the analysis network gₐ to achieve the latent representation y. The latent representation y is quantized and compressed into bits. The number of bits R is used to measure the coding rate. The quantized latent representation ŷ is then inversely transformed by a synthesis network gₛ to obtain the reconstructed image \hat{x}. The distortion is calculated in a perceptual space by transforming x and \hat{x} with the function gₚ.

It is intuitive to apply auto-encoder network to lossy image compression. It only needs to encode the learned latent representation from the well-trained neural networks. However, it is not trivial to adapt auto-encoder to image compression since the original auto-encoder is not optimized for compression thereby not efficient by directly using a trained auto-encoder. In addition, there exist other major challenges: First, the low-dimension representation should be quantized before being encoded, but the quantization is not differentiable, which is required in backpropagation while training the neural networks. Second, the objective under compression scenario is different since both the distortion and the rate need to be take into consideration. Estimating the rate is challenging. Third, a practical image coding scheme needs to support variable rate, scalability, encoding/decoding speed, interoperability. In response to these challenges, a number of researchers have been actively contributing to this area.

The prototype auto-encoder for image compression is in FIG. 2, which can be regarded as a transform coding strategy. The original image x is transformed with the analysis network y=gₐ(x), where y is the latent representation which will be quantized and coded. The synthesis network will inversely transform the quantized latent representation ŷ back to obtain the reconstructed image i=gₛ(y). The framework is trained with the rate-distortion loss function, i.e., [symbol] =D+λR, where D is the distortion between x and \hat{x}, R is the rate calculated or estimated from the quantized representation ŷ, and λ is the Lagrange multiplier. It should be noted that D can be calculated in either pixel domain or perceptual domain. All existing research works follow this prototype and the difference might only be the network structure or loss function.

### 2.3.3. Hyper Prior Model

In the transform coding approach to image compression, the encoder subnetwork (section 2.3.2) transforms the image vector x using a parametric analysis transform gₐ(x,Ø_{g}) into a latent representation y, which is then quantized to form ŷ. Because ŷ is discrete-valued, it can be losslessly compressed using entropy coding techniques such as arithmetic coding and transmitted as a sequence of bits.

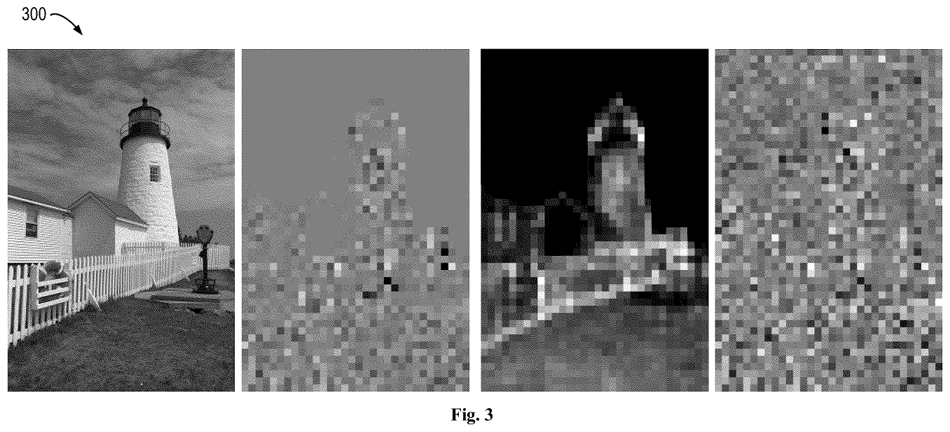

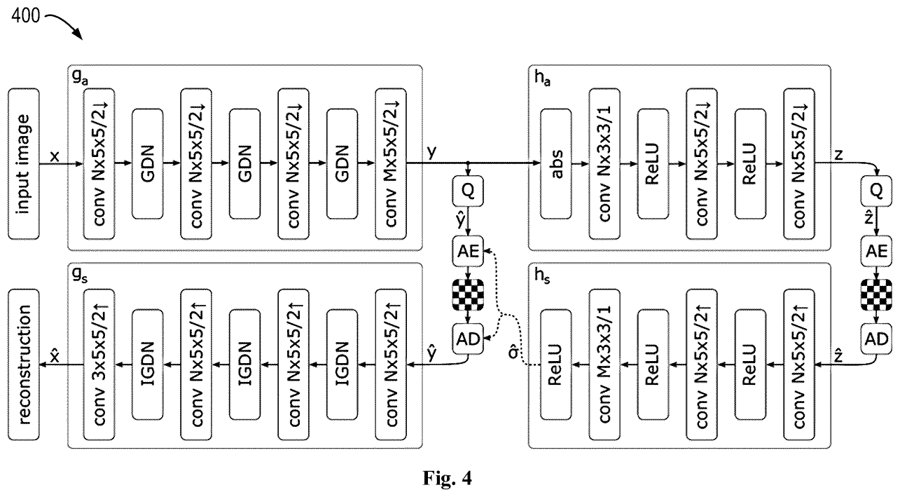

As evident from the middle left and middle right image of FIG. 3, there are significant spatial dependencies among the elements of ŷ. Notably, their scales (middle right image) appear to be coupled spatially. In an existing design, an additional set of random variables \hat{z} are introduced to capture the spatial dependencies and to further reduce the redundancies. In this case the image compression network is depicted in FIG. 4.

In FIG. 4, the left hand of the models is the encoder gₐ and decoder gₛ (explained in section 2.3.2). The right-hand side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses it to compress and transmit the quantized image representation ŷ. The decoder first recovers 2 from the compressed signal. It then uses hₛ to obtain σ, which provides it with the correct probability estimates to successfully recover ŷ as well. It then feeds ŷ into gₛ to obtain the reconstructed image.

When the hyper encoder and hyper decoder are added to the image compression network, the spatial redundancies of the quantized latent ŷ are reduced. The rightmost image in FIG. 3 correspond to the quantized latent when hyper encoder/decoder are used. Compared to middle right image, the spatial redundancies are significantly reduced, as the samples of the quantized latent are less correlated.

FIG. 3 illustrates an image from the Kodak dataset and different representations of the image. The leftmost image in FIG. 3 shows an image from the Kodak dataset. The middle left image in FIG. 3 shows visualization of a latent representation y of that image. The middle right image in FIG. 3 shows standard deviations σ of the latent. The rightmost image in FIG. 3 shows latents y after the hyper prior (hyper encoder and decoder) network is introduced. FIG. 4 illustrates a network architecture of an autoencoder implementing the hyperprior model. The left side shows an image autoencoder network, the right side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model consists of two subnetworks, hyper encoder (denoted with hₐ) and hyper decoder (denoted with hₛ). The hyper prior model generates a quantized hyper latent (\hat{z}) which comprises information about the probability distribution of the samples of the quantized latent ŷ. \hat{z} is included in the bitstream and transmitted to the receiver (decoder) along with ŷ.

### 2.3.4. Context Model

Although the hyperprior model improves the modelling of the probability distribution of the quantized latent ŷ, additional improvement can be obtained by utilizing an autoregressive model that predicts quantized latents from their causal context (Context Model).

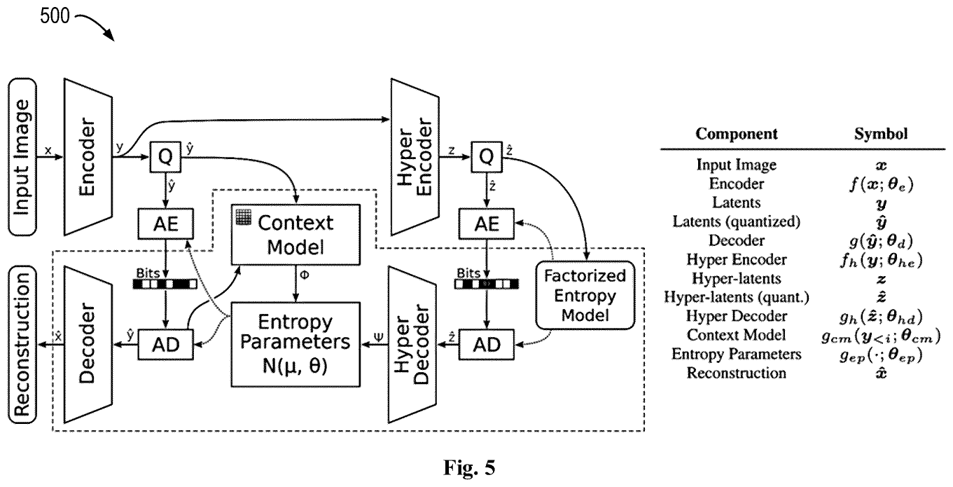

The term auto-regressive means that the output of a process is later used as input to it. For example the context model subnetwork generates one sample of a latent, which is later used as input to obtain the next sample. In an existing design, a joint architecture is utilized where both hyperprior model subnetwork (hyper encoder and hyper decoder) and a context model subnetwork are utilized. The hyperprior and the context model are combined to learn a probabilistic model over quantized latents ŷ, which is then used for entropy coding. As depicted in FIG. 5, the outputs of context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

FIG. 5 illustrates a block diagram of a combined model. The combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The highlighted region corresponds to the components that are executed by the receiver (i.e. a decoder) to recover an image from a compressed bitstream. Typically, the latent samples are modeled as gaussian distribution or gaussian mixture models (not limited to). In an existing design and according to the FIG. 5, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5. Gained Variational Autoencoders (G-VAE)

Typically, neural network-based image/video compression methodologies need to train multiple models to adapt to different rates. Gained variational autoencoders (G-VAE) is the variational autoencoder with a pair of gain units, which is designed to achieve continuously variable rate adaptation using a single model. It comprises of a pair of gain units, which are typically inserted to the output of encoder and input of decoder. The output of the encoder is defined as the latent representation y∈R^{c*h*w}, where c, h, w represent the number of channels, the height and width of the latent representation. Each channel of the latent representation is denoted as y₍ᵢ₎∈R^{h*w}, where i=0, 1, . . . , c−1. A pair of gain units include a gain matrix M∈R^{c*n} and an inverse gain matrix, where n is the number of gain vectors. The gain vector can be denoted as mₛ={αₛ₍₀₎, αₛ₍₁₎, . . . , α_{s(c-1)}}, αₛ₍ᵢ₎∈R where s denotes the index of the gain vectors in the gain matrix.

The motivation of gain matrix is similar to the quantization table in JPEG by controlling the quantization loss based on the characteristics of different channels. To apply the gain matrix to the latent representation, each channel is multiplied with the corresponding value in a gain vector.

$${\overline{y}}_{s} = y ⊙ {m}_{s}$$

Where ⊙ is channel-wise multiplication, i.e., y̅ₛ₍ᵢ₎=y₍ᵢ₎×αₛ₍ᵢ₎, and αₛ₍ᵢ₎ is the i-th gain value in the gain vector mₛ. The inverse gain matrix used at the decoder side can be denoted as M′∈R^{c*n}, which consists of n inverse gain vectors, i.e., M′={δₛ₍₀₎, δₛ₍₁₎, . . . , δ_{s(c-1)}}, δₛ₍ᵢ₎∈R. The inverse gain process is expressed as:

$${y}_{s}^{′} = \hat{y} ⊙ {m}_{s}^{′}$$

where ŷ is the decoded quantized latent representation and

$${y}_{s}^{′}$$

is the inversely gained quantized latent representation, which will be fed into the synthesis network.

To achieve continuous variable rate adjustment, interpolation is used between vectors. Given two pairs of gain vectors {mₜ,

$${m}_{t}^{′} \}$$

and {mᵣ,

$${m}_{r}^{′} \} ,$$

the interpolated gain vector can be obtained via the following equations.

$$\begin{matrix}{m}_{v} = [ {( {m}_{r} )}^{l} \cdot {( {m}_{t} )}^{1 - l} ] \\ {m}_{v}^{′} = [ {( {m}_{r}^{′} )}^{l} \cdot {( {m}_{t}^{′} )}^{1 - l} ]\end{matrix}$$

where l∈R is an interpolation coefficient, which controls the corresponding bit rate of the generated gain vector pair. Since l is a real number, an arbitrary bit rate between the given two gain vector pairs can be achieved.

### 2.3.6. The Encoding Process Using Joint Auto-Regressive Hyper Prior Model

FIG. 5 corresponds to the state of the art compression method that is proposed in an existing design. In this section and the next, the encoding and decoding processes will be described separately.

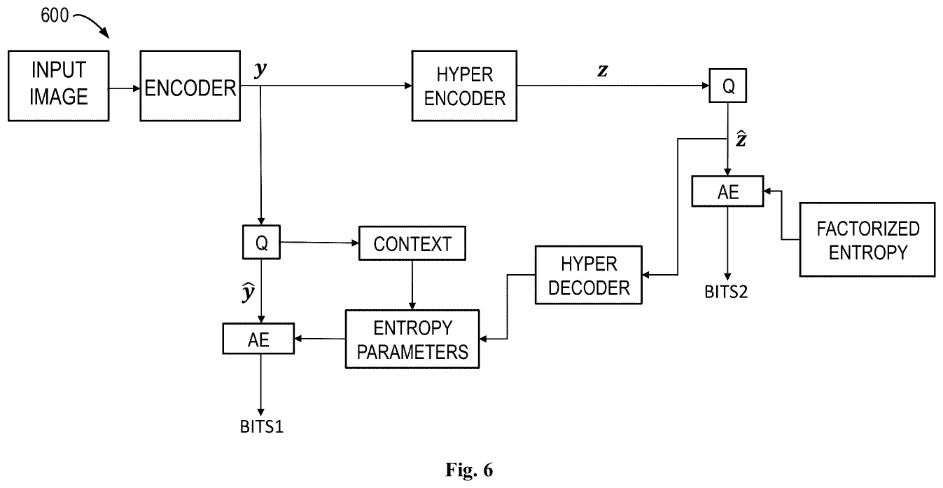

FIG. 6 depicts the encoding process. The input image is first processed with an encoder subnetwork. The encoder transforms the input image into a transformed representation called latent, denoted by y. y is then input to a quantizer block, denoted by Q, to obtained the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. The latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. In an existing design, the entropy parameters module are used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).

Finally the first and the second bitstream are transmitted to the decoder as result of the encoding process. It is noted that the other names can be used for the modules described above. In the above description, the all of the elements in FIG. 6 are collectively called encoder. The analysis transform that converts the input image into latent representation is also called an encoder (or auto-encoder).

### 2.3.7. The Decoding Process Using Joint Auto-Regressive Hyper Prior Model

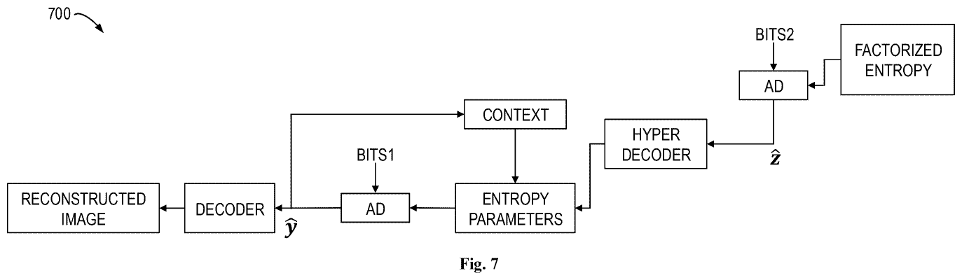

The FIG. 7 depicts the decoding process separately. In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore the exact same probability distributions can be obtained in the decoder (as in encoder), which is essential for reconstructing the quantized latent ŷ without any loss. As a result the identical version of the quantized latent ŷ that was obtained in the encoder can be obtained in the decoder. After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization.

Finally the fully reconstructed quantized latent ŷ is input to the synthesis transform (denoted as decoder in FIG. 7) module to obtain the reconstructed image.

In the above description, the all of the elements in FIG. 7 are collectively called decoder. The synthesis transform that converts the quantized latent into reconstructed image is also called a decoder (or auto-decoder).

### 2.4. Neural Networks for Video Compression

Similar to conventional video coding technologies, neural image compression serves as the foundation of intra compression in neural network-based video compression, thus development of neural network-based video compression technology comes later than neural network-based image compression but needs far more efforts to solve the challenges due to its complexity. Starting from 2017, a few researchers have been working on neural network-based video compression schemes. Compared with image compression, video compression needs efficient methods to remove inter-picture redundancy. Inter-picture prediction is then a crucial step in these works. Motion estimation and compensation is widely adopted but is not implemented by trained neural networks until recently.

Studies on neural network-based video compression can be divided into two categories according to the targeted scenarios: random access and the low-latency. In random access case, it requires the decoding can be started from any point of the sequence, typically divides the entire sequence into multiple individual segments and each segment can be decoded independently. In low-latency case, it aims at reducing decoding time thereby usually merely temporally previous frames can be used as reference frames to decode subsequent frames.

### 2.5. Preliminaries

Almost all the natural image/video is in digital format. A grayscale digital image can be represented by x∈ [symbol] , where [symbol] is the set of values of a pixel, m is the image height and n is the image width. For example, [symbol] ={0, 1, 2, . . . , 255} is a common setting and in this case | [symbol] |=256=2⁸, thus the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] with three separate channels storing Red, Green and Blue information. Similar to the 8-bit grayscale image, an uncompressed 8-bit RGB image has 24 bpp. Digital images/videos can be represented in different color spaces. The neural network-based video compression schemes are mostly developed in RGB color space while the traditional codecs typically use YUV color space to represent the video sequences. In YUV color space, an image is decomposed into three channels, namely Y, Cb and Cr, where Y is the luminance component and Cb/Cr are the chroma components. The benefits come from that Cb and Cr are typically down sampled to achieve pre-compression since human vision system is less sensitive to chroma components.

A color video sequence is composed of multiple color images, called frames, to record scenes at different timestamps. For example, in the RGB color space, a color video can be denoted by X={x₀, x₁, . . . , xₜ, . . . , x_{T-1}} where T is the number of frames in this video sequence, x∈ [symbol] . If m=1080, n=1920, | [symbol] |=2⁸, and the video has 50 frames-per-second (fps), then the data rate of this uncompressed video is 1920×1080×8×3×50=2,488,320,000 bits-per-second (bps), about 2.32 Gbps, which needs a lot storage thereby definitely needs to be compressed before transmission over the internet.

Usually the lossless methods can achieve compression ratio of about 1.5 to 3 for natural images, which is clearly below requirement. Therefore, lossy compression is developed to achieve further compression ratio, but at the cost of incurred distortion. The distortion can be measured by calculating the average squared difference between the original image and the reconstructed image, i.e., mean-squared-error (MSE). For a grayscale image, MSE can be calculated with the following equation.

$$MSE = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$PSNR = 10 \times {log}_{10} \frac{{( max ( 𝔻 ) )}^{2}}{MSE} \qquad ( 5 )$$

where max( [symbol] ) is the maximal value in [symbol] , e.g., 255 for 8-bit grayscale images. There are other quality evaluation metrics such as structural similarity (SSIM) and multi-scale SSIM (MS-SSIM).

To compare different lossless compression schemes, it is sufficient to compare either the compression ratio given the resulting rate or vice versa. However, to compare different lossy compression methods, it has to take into account both the rate and reconstructed quality. For example, to calculate the relative rates at several different quality levels, and then to average the rates, is a commonly adopted method; the average relative rate is known as Bjontegaard's delta-rate (BD-rate). There are other important aspects to evaluate image/video coding schemes, including encoding/decoding complexity, scalability, robustness, and so on.

### 2.5.1. Separate Processing of Luma and Chroma Components of an Image

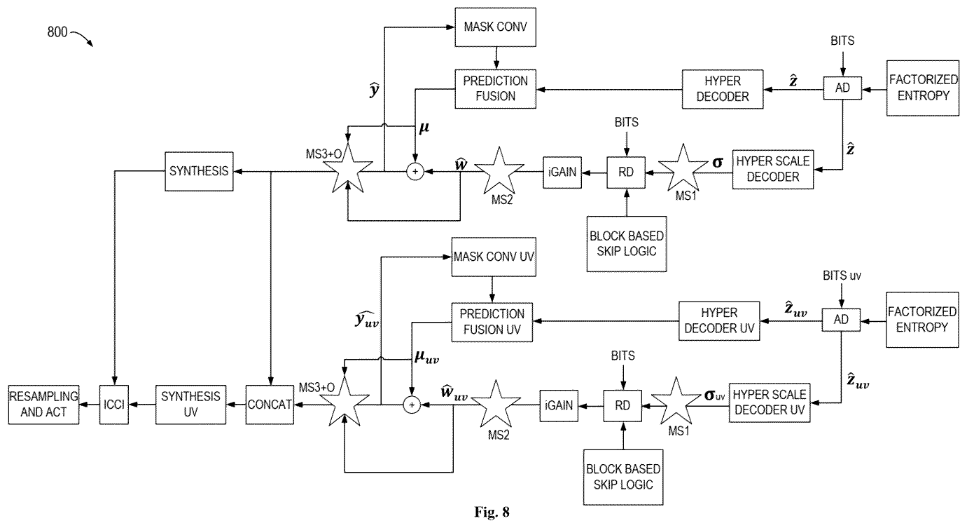

According to one implementation, the luma and chroma components of an image can be decoded using separate subnetworks. FIG. 8 illustrates an example of decoding process according to some embodiments of the present disclosure. In FIG. 8, the luma component of the image is processed by the subnetwoks “Synthesis”, “Prediction fusion”, “Mask Conv”, “Hyper Decoder”, “Hyper scale decoder” etc. Whereas the chroma components are processed by the subnetworks: “Synthesis UV”, “Prediction fusion UV”, “Mask Conv UV”, “Hyper Decoder UV”, “Hyper scale decoder UV” etc.

A benefit of the above separate processing is that the computational complexity of the processing of an image is reduced by application of separate processing. Typically in neural network based image and video decoding, the computational complexity is proportional to the square of the number of feature maps. If the number of total feature maps is equal to 192 for example, computational complexity will be proportional to 192×192. On the other hand if the feature maps are divided into 128 for luma and 64 for chroma (in the case of separate processing), the computational complexity is proportional to 128×128+64×64, which corresponds to a reduction in complexity by 45%. Typically the separate processing of luma and chroma components of an image does not result in a prohibitive reduction in performance, as the correlation between the luma and chroma components are typically very small.

The processing (Decoding process) in FIG. 8 can be explained below:
1. Firstly, the factorized entropy model is used to decode the quantized latents for luma and chroma, i.e., \hat{z} and \hat{z}ᵤᵥ in FIG. 8.
2. The probability parameters (e.g. variance) generated by the second network are used to generate a quantized residual latent by performing the arithmetic decoding process.
3. The quantized residual latent is inversely gained with the inverse gain unit (iGain) as shown in orange color in FIG. 8. The outputs of the inverse gain units are denoted as ŵ and ŵᵤᵥ for luma and chroma components, respectively.
4. For the luma component, the following steps are performed in a loop until all elements of y are obtained:
   a. A first subnetwork is used to estimate a mean value parameter of a quantized latent (ŷ), using the already obtained samples of ŷ.
   b. The quantized residual latent w and the mean value are used to obtain the next element of f.
5. After all of the samples of ŷ are obtained, a synthesis transform can be applied to obtain the reconstructed image.
6. For chroma component, step 4 and 5 are the same but with a separate set of networks.
7. The decoded luma component is used as additional information to obtain the chroma component. Specifically, the Inter Channel Correlation Information filter sub-network (ICCI) is used for chroma component restoration. The luma is fed into the ICCI sub-network as additional information to assist the chroma component decoding.
8. Adaptive color transform (ACT) is performed after the luma and chroma components are reconstructed.

The module named ICCI is a neural-network based postprocessing module. The present disclosure is not limited to the UCCI subnetwork, any other neural network based postprocessing module might also be used.

An exemplary implementation of the some embodiments of the present disclosure is depicted in FIG. 8 (the decoding process). The framework comprises two branches for luma and chroma components respectively. In each of the branch, the first subnetwork comprises the context, prediction and optionally the hyper decoder modules. The second network comprises the hyper scale decoder module. The quantized hyper latent are \hat{z} and \hat{z}ᵤᵥ. The arithmetic decoding process generates the quantized residual latents, which are further fed into the iGain units to obtain the gained quantized residual latents ŵ and ŵᵤᵥ.

After the residual latent is obtained, a recursive prediction operation is performed to obtain the latent ŷ and ŷᵤᵥ. The following steps describe how to obtain the samples of latent ŷ[:,i,j], and the chroma component is processed in the same way but with different networks.
1. An autoregressive context module is used to generate first input of a prediction module using the samples ŷ[:,m,n] where the (m, n) pair are the indices of the samples of the latent that are already obtained.
2. Optionally the second input of the prediction module is obtained by using a hyper decoder and a quantized hyper latent [symbol] .
3. Using the first input and the second input, the prediction module generates the mean value mean[:,i,j].
4. The mean value mean[:,i,j] and the quantized residual latent [:,i,j] are added together to obtain the latent y[:,i,j].
5. The steps 1-4 are repeated for the next sample.

Whether to and/or how to apply at least one method disclosed in the document may be signaled from the encoder to the decoder, e.g. in the bitstream.

Alternatively, whether to and/or how to apply at least one method disclosed in the document may be determined by the decoder based on coding information, such as dimensions, color format, etc.

Alternative or additionally, the modules named MS1, MS2 or MS3+O (in FIG. 8), might be included in the processing flow. The said modules might perform an operation to their input by multiplying the input with a scalar or adding an adding an additive component to the input to obtain the output. The scalar or the additive component that are used by the said modules might be indicated in a bitstream.

The module named RD or the module named AD in FIG. 8 might be an entropy decoding module. It might be a range decoder or an arithmetic decoder or the like.

The solution described herein is not limited to the specific combination of the units exemplified in FIG. 8. Some of the modules might be missing and some of the modules might be displaced in processing order. Also additional modules might be included. For example:
1. The ICCI module might be removed. In that case the output of the Synthesis module and the Synthesis UV module might be combined by means of another module, that might be based on neural networks.
2. One or more of the modules named MS1, MS2 or MS3+O might be removed. The core of the solution is not affected by the removing of one or more of the said scaling and adding modules.

In FIG. 8, other operations that are performed during the processing of the luma and chroma components are also indicated using the star symbol. These processes are denoted as MS1, MS2, MS3+O. These processing might be, but not limited to, adaptive quantization, latent sample scaling, and latent sample offsetting operations. For example, in an adaptive quantization process might correspond to scaling of a sample with multiplier before the prediction process, wherein the multiplier is predefined or whose value is indicated in the bitstream. The latent scaling process might correspond to the process where a sample is scaled with a multiplier after the prediction process, wherein the value of the multiplier is either predefined or indicated in the bitstream. The offsetting operation might correspond to adding an additive element to the sample, again wherein the value of the additive element might be indicated in the bitstream or inferred or predetermined.

Another operation might be tiling operation, wherein samples are first tiled (grouped) into overlapping or non-overlapping regions, wherein each region is processed independently. For example the samples corresponding to the luma component might be divided into tiles with a tile height of 20 samples, whereas the chroma components might be divided into tiles with a tile height of 10 samples for processing.

Another operation might be application of wavefront parallel processing. In wavefront parallel processing, a number of samples might be processed in parallel, and the amount of samples that can be processed in parallel might be indicated by a control parameter. The said control parameter might be indicated in the bitstream, be inferred, or can be predetermined. In the case of separate luma and chroma processing, the number of samples that can be processed in parallel might be different, hence different indicators can be signalled in the bitstream to control the operation of luma and chrome processing separately.

### 3. PROBLEMS

### 3.1. The Core Problem

In section 2.5.1 different processes are exemplified in the case of separate processing of luma and chroma components. Since the luma and chroma components are processed separately, different sets of control parameters are required to be signalled in the bitstream to control different processing stages. For example one set of indicators would necessary to be signalled for the adaptive quantization process for luma component, and a second set of parameters would be necessary to be signalled for the adaptive quantization process of the chroma component. Similarly for scaling of the samples, offsetting of samples, tiling of the samples, etc., would require two sets of control parameters. One set to control the behavior of the processing step for luma component and the second set to control the behavior of the processing step for the chroma component.

The necessity of signalling 2 sets of control parameters separately for luma and chroma components result in an increase in the bitrate, and hence a reduction in compression performance.

### 4. DETAILED SOLUTIONS

The detailed solutions below should be considered as examples to explain general concepts. These solutions should not be interpreted in a narrow way. Furthermore, these solutions can be combined in any manner.

The proposed solution related to separate processing of components of an image with neural networks. A mechanism for sharing of control parameters is disclosed, wherein the processing of luma and chroma components can share the part or whole of the set of control parameters.

### 4.1. Core of the Solution

The target of the proposed solution is to provide a mechanism for signalling control parameters for coding tools that can be used in processing of at least two components of an image. In one example one component might be a luma component and the second component might be a chroma component.

### 4.2. Details of the Solution

In FIG. 8, a compression network is depicted wherein the luma and chroma components of the image are reconstructed separately. Furthermore example operations are depicted, such as MS2, that is used to process the residual latent samples. The process of MS2 for example can be adaptive quantization process, wherein the input of the MS2 process (quantized residual samples) are multiplied with a multiplier that is signaled in the bitstream.

The adaptive quantization process typically consists of:
At the encoder a scaling process of the residual samples before quantization.
Quantization of the scaled residual samples at the encoder.
Receiving of the quantized residual samples at the decoder.
An inverse scaling operation at the decoder.

The values of the scalar (used in inverse scaling) need to be included in the bitstream in order the decoder to successfully do the inverse scaling operation. In this case the control parameter of the adaptive quantization process is the scalar value, which controls the magnitude of the scaling operation.

According to the proposed solution:
A neural network-based image or video decoding method, wherein the said image or video comprises at least the components, comprising the steps of:
   Obtaining an indicator from the bitstream,
   obtaining a set of control parameters,
   if the value of the indicator is equal to a predefined value, using the set of control parameters in the processing of both components of the image or video,
   if the value of the indicator is equal to a second predefined value, using the set of control parameters in processing of only one of the components.
Combining the processed at least 2 components to reconstruct the image or video.

According to the proposed solution, an indicator is included in the bitstream. The indicator controls the usage of control parameters associated with a coding tool (such as adaptive quantization as exemplified above). If the indicator assumes a predefined value “A”, e.g. the “A” might be equal to 1, the same control parameter set is used in the processing of both components of an image. The components might be a luma component and a chroma component. In another example the components might be a Red component, and/or a Green Component, and/or a Blue component. On the other hand if the value of the indicator is equal to a second predefined value “B”, e,g, the “B” might be equal to 0, the control parameter set is applied in the processing of only one of the components. In such a case, the other component might either be not processed with the process that utilizes the said control parameter set, or a second set of control parameters are used.

According to one example implementation of the proposed solution, 3 indicators might be included in the bitstream, with the following functions:
1. The first indicator indicates whether a coding tool is used in the processing of one component of the image.
2. The second indicator indicates whether a coding tool is used in the processing of other components of the image.
3. If both indicators indicate that the coding tool is used in both components, a third indicators is included in the bitstream to indicate whether the control parameters used in processing both components are same or not. If the control parameters are indicated to be same, only a single control parameter set is included in the bitstream to process both components.

The coding tool that is controlled by the control parameter set might be (not limited to) adaptive quantization, sample scaling, skip mode, tiling, sample offsetting, wavefront parallel processing, tiling etc. For example the skip mode corresponds to processing samples in such a way that based on a threshold it is decided whether a sample is included in the bitstream or not. The control parameter set corresponding to skip mode might include the value of the threshold. The tiling corresponds to grouping of samples into at least 2 groups and processing them independently or in parallel. The control parameter set corresponding to tiling might include tile size or number of tiles or tile partition modes.

According to another example implementation of the proposed solution, an indicator might be included in the bitstream to indicate one of the following options:
1. The coding tool is turned off for processing of all components.
2. The coding tool is turned on for processing of only one component. Only one set of control parameters is included in the bitstream for the coding tool.
3. The coding tool is turned on for processing of two components. Only one set of control parameters is included in the bitstream for the coding tool and applied in the processing of both components.
4. The coding tool is turned on for processing of two components. Only one set of control parameters is included in the bitstream for the coding tool. The first component and/or the second component employs the signaled control parameters. The second component and/or the first component employ a derived set of control parameters. The derived operations may be but not limited to rescaling, resampling, etc.
5. The coding tool is turned on for processing of two components. Two sets of control parameters are included in the bitstream for the coding tool and one set of control parameters is used in the processing of one component, and the second set of control parameters is used in the processing of the second component.

According to another example implementation of the proposed solution, an indicator might be included in the bitstream to indicate if the set of control parameters of one component is identical to the other component. As an example:
1. A first set of control parameters is included in the bitstream and is used in the processing of a first component.
2. An indicator is included in the bitstream to indicate if the processing of the second component uses the same set of control parameters as the first component. If true, the same set of control parameters are used to process the second component. Otherwise a second set of control parameters is included in the bitstream and used in the processing of the second component. Alternatively, the second set of control parameters may be derived according to the first set of control parameters and used in processing of the second component.

According to another example implementation of the proposed solution, a first indicator might be included in the bitstream to indicate the number of control parameter sets, which can be denoted as N. After the first indicator, N second indicators might be included in the bitstream corresponding to each control parameter set. Each second indicator might indicate:
If the corresponding control parameter set applies only to first component,
If the corresponding control parameter set applies only to second component,
If the corresponding control parameter set applies to both components.

In the above example, N control parameter sets are included in the bitstream. The control parameter sets might control the same coding tool. If N control parameter sets are included in the bitstream to control a coding tool, this might correspond to repetitive application of the same coding tool N times, using a different set each time of the application.

The N control parameter sets are included in the bitstream might correspond to different coding tools. One parameter set might correspond to adaptive quantization, other parameter set might correspond to wavefront parallel processing etc. In the example above, an indicator is included in the bitstream to corresponding to at least one of control parameter set, and it controls whether the control parameter set is applied to a first component, a second component or both.

According to another example implementation of the proposed solution, a control parameter set is included in the bitstream to control a coding tool. Corresponding to the control parameter set, an indicator is included in the bitstream to indicate:
If the corresponding control parameter set applies only to first component,
If the corresponding control parameter set applies only to second component,
If the corresponding control parameter set applies to both components.

### 4.3. Benefit of the Solution

According to the proposed solution, the side information necessary for processing multiple components of an image is reduced.

### 5. EMBODIMENTS

### 1. Decoder Embodiment

An image or video decoding method, comprising a neural network, that comprise the steps of:
Obtaining a control parameter set from a bitstream,
Obtaining an indicator from the bitstream, that indicates whether the control parameter set is used during the processing of a first component, or during the processing of a second component, or if it is used during the processing of both components,
Processing one component with a first neural subnetwork and the second component with a second neural subnetwork,

Obtaining a reconstructed image by combining the outputs of the first and second neural subnetworks.

More details of the embodiments of the present disclosure will be described below which are related to neural network-based visual data coding. As used herein, the term “visual data” may refer to a video, an image, a picture in a video, or any other visual data suitable to be coded.

As discussed above, in the existing design, values for a control parameter set are signal separately for luma and chroma components. For example, even when a scaling factor for the sample scaling process is the same for processing luma and chroma components. The value of this scaling factor needs to be signaled twice, i.e., once for processing the luma component and once for processing the chroma component. This results in an increase in the bitrate, and thus the compression performance and coding efficiency deteriorates.

To solve the above problems and some other problems not mentioned, visual data processing solutions as described below are disclosed. The embodiments of the present disclosure should be considered as examples to explain the general concepts and should not be interpreted in a narrow way. Furthermore, these embodiments can be applied individually or combined in any manner.

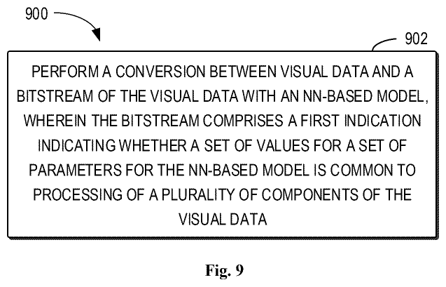

FIG. 9 illustrates a flowchart of a method 900 for visual data processing in accordance with some embodiments of the present disclosure. As shown in FIG. 9, at 902, a conversion between visual data and a bitstream of the visual data is performed with a neural network (NN)-based model. In some embodiments, the conversion may include encoding the visual data into the bitstream. Additionally or alternatively, the conversion may include decoding the visual data from the bitstream. For example, the decoding model shown in FIG. 8 may be employed for decoding the visual data from the bitstream.

In some embodiments, the bitstream comprises a first indication indicating whether a set of values for a set of parameters for the NN-based model is common to processing of a plurality of components of the visual data. By way of example rather than limitation, the first indication may be a flag, a syntax element, or the like. For example, if the set of values for the set of parameters is common to processing of the plurality of component, each of the plurality of components may be processed by using the set of values for the set of parameters. In other words, the set of values for the set of parameters is the same for processing the plurality of components.

In some embodiments, the plurality of components may comprise a luma component, a chroma component, a red component, a green component, a blue component, a Y component, a U component, a V component, a chroma blue (Cb) component, and/or a chroma red (Cr) component. It should be understood that the plurality of components may comprise any other suitable component, such as, an alpha component for transparency. The scope of the present disclosure is not limited in this respect.

In some embodiments, the plurality of components of the visual data may be processed at least partially separately. By way of example, the plurality of components may comprise the luma component and the chroma component of the visual data. With reference to FIG. 8, the luma and chroma components may be processed separately using modules consisting of same sequence of same neural-network layers, with the difference in sizes on input tensors and number of tensor channels. The first indication may indicate whether a value for at least one parameter for the NN-based model is common to processing of the luma and chroma components. If the value for the at least one parameter is common to processing of the luma and chroma components, the value for the at least one parameter may be signaled only once, rather than being signaled separately for the luma and chroma components. Thereby, side information necessary for processing multiple components of the visual data is reduced.

In view of the above, an indication is comprised in the bitstream and indicates whether a set of values for a set of parameters for the NN-based model is common to processing of a plurality of components of the visual data. In aid of this indication, it is possible to avoid signaling the set of values separately for the plurality of components of the visual data. Thereby, the proposed method can advantageously improve coding efficiency.

In some embodiments, the set of parameters may be used for a first coding tool of the NN-based model. As used herein, the term “coding tool” may refer to any suitable sub-process in the processing the visual data, and a coding tool may be implemented as a tool, a unit, a module, or the like. By way of example, the first coding tool may comprise an adaptive quantization, a sample scaling, a skip mode, a tiling, a sample offsetting, a gain unit, an inverse gain unit, a filter, an inter channel correlation information (ICCI) filter, a gain process, an inverse gain process, a postprocessing module, a hyper decoder module, a hyper scale decoder module, and/or a wavefront parallel processing. It should be understood that the possible implementations of the first coding tool described here are merely illustrative and therefore should not be construed as limiting the present disclosure in any way.

In some embodiments, the set of parameters may comprise a single parameter. In such a case, the set of values may comprise a single value for the single parameter. Alternatively, the set of parameters may comprise a plurality of parameters. In this case, the set of values may also comprise a plurality of values, and each of the plurality of values corresponds to one of the plurality of parameters. For example, the number of values in the set of values may be equal to the number of parameters in the set of parameters.

In some embodiments, the set of parameters may comprise any suitable parameter used for the first coding tool. By way of example rather than limitation, dependent on the first coding tool, the set of parameters may comprise a scalar, a multiplier, a vector, a scaling factor, a threshold, a tile size, the number of tiles, a tile partition mode, an index, a model, an offset, an additive coefficient, a subtractive coefficient, and/or the number of samples processed in parallel. For example, if the first coding tool is a skip mode, the set of parameters may comprise a threshold for determining whether a sample is included in the bitstream or not. In another example, if the first coding tool is a tiling process, the set of parameters may comprise a tile size, the number of tiles, and/or a tile partition mode. In a further example, the offset may be implemented as a displacement term. It should be understood that the above examples are described merely for purpose of description. The scope of the present disclosure is not limited in this respect.

In some embodiments, the set of values for the set of parameters may be indicated in the bitstream. For example, at the decoder side, the set of values may be obtained by decoding the bitstream. Alternatively, the set of values for the set of parameters may be pre-defined. In this case, the set of values does not need to be signaled, and thus the bitrate for coding the visual data can be advantageously further reduced.

In some embodiments, a value of the first indication equal to a first value may indicate that the set of values for the set of parameters is common to processing of the plurality of components. In addition, the value of the first indication equal to a second value may indicate that the set of values for the set of parameters is not common to processing of the plurality of components. The second value is different from the first value. In one example, the first value may be 1 and the second value may be 0. In another example, the first value may be 0 and the second value may be 1. It should be understood that the specific value recited here is intended to be exemplary rather than limiting the scope of the present disclosure.

In some embodiments, the bitstream may further comprise a second indication indicating whether the first coding tool is applied to a first component (such as, a chroma component or the like) in the plurality of components. Moreover, the bitstream may also comprise a third indication indicating whether the first coding tool is applied to a second component (such as, a luma component or the like) in the plurality of components. The second component is different from the first component. If both indicators indicate that the coding tool is used in both components, the first indication may be comprised in the bitstream to indicate whether a set of values for a set of parameters for the NN-based model is common to processing of the plurality of components.

In some embodiments, the first indication may further indicate at least one of the following: whether the first coding tool is applied to the plurality of components, at least one component in the plurality of components to which the first coding tool is applied, or at least one component in the plurality of components to which the set of values for the set of parameters is applied.

By way of example rather than limitation, in a case that the plurality of components comprises two components of the visual data. The first indication may indicate one the following options:
First Option: the first coding tool is not applied to these two components.
Second Option: the first coding tool is applied to only one component among these two components. Only one set of values for the set of parameters is comprised in the bitstream for the first coding tool.
Third Option: the first coding tool is applied to these two components. Only one set of values for the set of parameters is comprised in the bitstream for the first coding tool, and used for processing of both components.
Fourth Option: the first coding tool is applied to these two components. Only one set of values for the set of parameters is comprised in the bitstream for the first coding tool. One of the two components is processed by using this signaled set of values. Another one of the two components is processed by a further set of values determined based on the signaled set of values.
Fifth Option: the first coding tool is applied to these two components. Two sets of values for the set of parameters are comprised in the bitstream for the first coding tool. One of the two components is processed by using a first set of values among these two sets of values. Another one of the two components is processed by a second set of values among these two sets of values.

It should be understood that the above options are described merely for purpose of description. The scope of the present disclosure is not limited in this respect.

In some embodiments, the bitstream may further comprise a fourth indication indicating the number of a plurality of sets of parameters for at least one coding tool of the NN-based model. The plurality of sets of parameters may comprise the set of parameters for the first coding tool and the at least one coding tool may comprise the first coding tool. In such a case, for each set of values for each of the plurality of sets of parameters, an indication may be comprised in the bitstream to indicate whether this set of values is common to processing of a plurality of components of the visual data.

In some embodiments, the bitstream may further comprise a fifth indication indicating the number of a plurality of sets of values for the set of parameters for the first coding tool. In such a case, for each of the plurality of sets of values, an indication may be comprised in the bitstream to indicate whether this set of values is common to processing of a plurality of components of the visual data.

In some embodiments, if the set of values for the set of parameters is not common to processing of the plurality of components, the first indication may further indicate one or more component in the plurality of components to which the set of values for the set of parameters are applied.

In some embodiments, the set of values for the set of parameters may be common to processing of the plurality of components. In this case, each of the plurality of components may be processed by using the first coding tool with the set of values for the set of parameters.

In some embodiments, the set of values for the set of parameters may be not common to processing of the plurality of components and the set of values may be applied to a first component in the plurality of components. In such a case, a second component in the plurality of components, which is different from the first component, may be not processed with the first coding tool. Alternatively, the second component may be processed by using the first coding tool with a further set of values for the set of parameters, which is different from the set of values. In one example, the further set of values may be determined based on the set of values, e.g., through rescaling the set of values, resampling the set of values. or the like. In another example, the further set of values may be indicated in the bitstream. In a further example, the further set of values may be pre-defined.

According to further embodiments of the present disclosure, a non-transitory computer-readable recording medium is provided. The non-transitory computer-readable recording medium stores a bitstream of visual data which is generated by a method performed by an apparatus for visual data processing. In the method, a conversion between the visual data and the bitstream is performed with a neural network (NN)-based model. The bitstream comprises a first indication indicating whether a set of values for a set of parameters for the NN-based model is common to processing of a plurality of components of the visual data.

According to still further embodiments of the present disclosure, a method for storing a bitstream of visual data is provided. According to the method, a conversion between the visual data and the bitstream is performed with a neural network (NN)-based model. The bitstream comprises a first indication indicating whether a set of values for a set of parameters for the NN-based model is common to processing of a plurality of components of the visual data. Moreover, the bitstream is stored in a non-transitory computer-readable recording medium.

Implementations of the present disclosure can be described in view of the following clauses, the features of which can be combined in any reasonable manner.

Clause 1. A method for visual data processing, comprising: performing a conversion between visual data and a bitstream of the visual data with a neural network (NN)-based model, wherein the bitstream comprises a first indication indicating whether a set of values for a set of parameters for the NN-based model is common to processing of a plurality of components of the visual data.

Clause 2. The method of clause 1, wherein the set of parameters is used for a first coding tool of the NN-based model.

Clause 3. The method of any of clauses 1-2, wherein the plurality of components comprise at least one of the following: a luma component, a chroma component, a red component, a green component, a blue component, a Y component, a U component, a V component, a chroma blue (Cb) component, or a chroma red (Cr) component.

Clause 4. The method of any of clauses 2-3, wherein the first coding tool comprises at least one of the following: an adaptive quantization, a sample scaling, a skip mode, a tiling, a sample offsetting, a gain unit, an inverse gain unit, a filter, an inter channel correlation information (ICCI) filter, a gain process, an inverse gain process, a postprocessing module, a hyper decoder module, a hyper scale decoder module, or a wavefront parallel processing.

Clause 5. The method of any of clauses 1-4, wherein the set of parameters comprises at least one of the following: a scalar, a multiplier, a vector, a scaling factor, a threshold, a tile size, the number of tiles, a tile partition mode, an index, a model, an offset, an additive coefficient, or the number of samples processed in parallel.

Clause 6. The method of any of clauses 1-5, wherein the set of values for the set of parameters is indicated in the bitstream or predefined.

Clause 7. The method of any of clauses 1-6, wherein a value of the first indication equal to a first value indicates that the set of values for the set of parameters is common to processing of the plurality of components, or the value of the first indication equal to a second value indicates that the set of values for the set of parameters is not common to processing of the plurality of components, the second value being different from the first value.

Clause 8. The method of clause 7, wherein the first value is 1 and the second value is 0, or wherein the first value is 0 and the second value is 1.

Clause 9. The method of any of clauses 2-8, wherein the bitstream further comprises: a second indication indicating whether the first coding tool is applied to a first component in the plurality of components, and a third indication indicating whether the first coding tool is applied to a second component in the plurality of components, the second component being different from the first component.

Clause 10. The method of any of clauses 2-9, wherein the first indication further indicates at least one of the following: whether the first coding tool is applied to the plurality of components, at least one component in the plurality of components to which the first coding tool is applied, or at least one component in the plurality of components to which the set of values for the set of parameters is applied.

Clause 11. The method of any of clauses 2-10, wherein the bitstream further comprises a fourth indication indicating the number of a plurality of sets of parameters for at least one coding tool of the NN-based model, the plurality of sets of parameters comprise the set of parameters for the first coding tool and the at least one coding tool comprises the first coding tool, or wherein the bitstream further comprises a fifth indication indicating the number of a plurality of sets of values for the set of parameters for the first coding tool.

Clause 12. The method of any of clauses 1-11, wherein if the set of values for the set of parameters is not common to processing of the plurality of components, the first indication further indicates a component in the plurality of components to which the set of values for the set of parameters is applied.

Clause 13. The method of any of clauses 2-12, wherein the set of values for the set of parameters is common to processing of the plurality of components, and each of the plurality of components is processed by using the first coding tool with the set of values for the set of parameters.

Clause 14. The method of any of clauses 2-12, wherein the set of values for the set of parameters is not common to processing of the plurality of components and is applied to a first component in the plurality of components, and a second component in the plurality of components different from the first component is not processed with the first coding tool.

Clause 15. The method of any of clauses 2-12, wherein the set of values for the set of parameters is not common to processing of the plurality of components and is applied to a first component in the plurality of components, and a second component in the plurality of components different from the first component is processed by using the first coding tool with a further set of values for the set of parameters different from the set of values.

Clause 16. The method of clause 15, wherein the further set of values is determined based on the set of values, or the further set of values is indicated in the bitstream, or the further set of values is pre-defined.

Clause 17. The method of any of clauses 1-16, wherein the plurality of components of the visual data are processed at least partially separately.

Clause 18. The method of any of clauses 1-17, wherein the set of parameters comprises a single parameter, or wherein the set of parameters comprises a plurality of parameters.

Clause 19. The method of any of clauses 1-18, wherein the visual data comprise a video, a picture of the video, or an image.

Clause 20. The method of any of clauses 1-19, wherein the conversion includes encoding the visual data into the bitstream.

Clause 21. The method of any of clauses 1-19, wherein the conversion includes decoding the visual data from the bitstream.

Clause 22. An apparatus for visual data processing comprising a processor and a non-transitory memory with instructions thereon, wherein the instructions upon execution by the processor, cause the processor to perform a method in accordance with any of clauses 1-21.

Clause 23. A non-transitory computer-readable storage medium storing instructions that cause a processor to perform a method in accordance with any of clauses 1-21.

Clause 24. A non-transitory computer-readable recording medium storing a bitstream of visual data which is generated by a method performed by an apparatus for visual data processing, wherein the method comprises: performing a conversion between the visual data and the bitstream with a neural network (NN)-based model, wherein the bitstream comprises a first indication indicating whether a set of values for a set of parameters for the NN-based model is common to processing of a plurality of components of the visual data.

Clause 25. A method for storing a bitstream of visual data, comprising: performing a conversion between the visual data and the bitstream with a neural network (NN)-based model, wherein the bitstream comprises a first indication indicating whether a set of values for a set of parameters for the NN-based model is common to processing of a plurality of components of the visual data; and storing the bitstream in a non-transitory computer-readable recording medium.

### Example Device

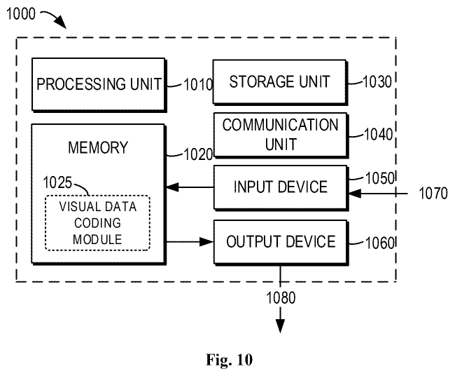

FIG. 10 illustrates a block diagram of a computing device 1000 in which various embodiments of the present disclosure can be implemented. The computing device 1000 may be implemented as or included in the source device 110 (or the visual data encoder 114) or the destination device 120 (or the visual data decoder 124).

It would be appreciated that the computing device 1000 shown in FIG. 10 is merely for purpose of illustration, without suggesting any limitation to the functions and scopes of the embodiments of the present disclosure in any manner.

As shown in FIG. 10, the computing device 1000 includes a general-purpose computing device 1000. The computing device 1000 may at least comprise one or more processors or processing units 1010, a memory 1020, a storage unit 1030, one or more communication units 1040, one or more input devices 1050, and one or more output devices 1060.

In some embodiments, the computing device 1000 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1000 can support any type of interface to a user (such as “wearable” circuitry and the like).

The processing unit 1010 may be a physical or virtual processor and can implement various processes based on programs stored in the memory 1020. In a multi-processor system, multiple processing units execute computer executable instructions in parallel so as to improve the parallel processing capability of the computing device 1000. The processing unit 1010 may also be referred to as a central processing unit (CPU), a microprocessor, a controller or a microcontroller.

The computing device 1000 typically includes various computer storage medium. Such medium can be any medium accessible by the computing device 1000, including, but not limited to, volatile and non-volatile medium, or detachable and non-detachable medium. The memory 1020 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1030 may be any detachable or non-detachable medium and may include a machine-readable medium such as a memory, flash memory drive, magnetic disk or another other media, which can be used for storing information and/or visual data and can be accessed in the computing device 1000.

The computing device 1000 may further include additional detachable/non-detachable, volatile/non-volatile memory medium. Although not shown in FIG. 10, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more visual data medium interfaces.

The communication unit 1040 communicates with a further computing device via the communication medium. In addition, the functions of the components in the computing device 1000 can be implemented by a single computing cluster or multiple computing machines that can communicate via communication connections. Therefore, the computing device 1000 can operate in a networked environment using a logical connection with one or more other servers, networked personal computers (PCs) or further general network nodes.

The input device 1050 may be one or more of a variety of input devices, such as a mouse, keyboard, tracking ball, voice-input device, and the like. The output device 1060 may be one or more of a variety of output devices, such as a display, loudspeaker, printer, and the like. By means of the communication unit 1040, the computing device 1000 can further communicate with one or more external devices (not shown) such as the storage devices and display device, with one or more devices enabling the user to interact with the computing device 1000, or any devices (such as a network card, a modem and the like) enabling the computing device 1000 to communicate with one or more other computing devices, if required. Such communication can be performed via input/output (I/O) interfaces (not shown).

In some embodiments, instead of being integrated in a single device, some or all components of the computing device 1000 may also be arranged in cloud computing architecture. In the cloud computing architecture, the components may be provided remotely and work together to implement the functionalities described in the present disclosure. In some embodiments, cloud computing provides computing, software, visual data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding visual data may be stored on a server at a remote position. The computing resources in the cloud computing environment may be merged or distributed at locations in a remote visual data center. Cloud computing infrastructures may provide the services through a shared visual data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1000 may be used to implement visual data encoding/decoding in embodiments of the present disclosure. The memory 1020 may include one or more visual data coding modules 1025 having one or more program instructions. These modules are accessible and executable by the processing unit 1010 to perform the functionalities of the various embodiments described herein.

In the example embodiments of performing visual data encoding, the input device 1050 may receive visual data as an input 1070 to be encoded. The visual data may be processed, for example, by the visual data coding module 1025, to generate an encoded bitstream. The encoded bitstream may be provided via the output device 1060 as an output 1080.

In the example embodiments of performing visual data decoding, the input device 1050 may receive an encoded bitstream as the input 1070. The encoded bitstream may be processed, for example, by the visual data coding module 1025, to generate decoded visual data. The decoded visual data may be provided via the output device 1060 as the output 1080.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for visual data processing, comprising:
performing a conversion between visual data and a bitstream of the visual data with a neural network (NN)-based model, wherein the bitstream comprises a first indication indicating whether a value for a parameter for the NN-based model is common to processing of a plurality of components of the visual data.

2. The method of claim 1, wherein the parameter is used for a first coding tool of the NN-based model.

3. The method of claim 1, wherein the plurality of components comprise at least one of the following:
a luma component,
a chroma component,
a Y component,
a U component,
a V component,
a chroma blue (Cb) component, or
a chroma red (Cr) component.

4. The method of claim 2, wherein the first coding tool comprises at least one of the following:
a sample scaling,
a sample offsetting, or
a gain unit.

5. The method of claim 1, wherein the parameter comprises an offset.

6. The method of claim 1, wherein the value for the parameter is indicated in the bitstream.

7. The method of claim 1, wherein a value of the first indication equal to a first value indicates that the value for the parameter is common to processing of the plurality of components, or
the value of the first indication equal to a second value indicates that the value for the parameter is not common to processing of the plurality of components, the second value being different from the first value.

8. The method of claim 7, wherein the first value is false and the second value is true.

9. The method of claim 2, wherein the first indication further indicates at least one component in the plurality of components to which the value for the parameter is applied.

10. The method of claim 1, wherein if the value for the parameter is not common to processing of the plurality of components, the first indication further indicates a component in the plurality of components to which the value for the parameter is applied.

11. The method of claim 2, wherein if the value for the parameter is common to processing of the plurality of components, each of the plurality of components is processed by using the first coding tool with the value for the parameter.

12. The method of claim 2, wherein if the value for the parameter is not common to processing of the plurality of components, the value for the parameter is applied to a first component in the plurality of components, and a second component in the plurality of components different from the first component is processed by using the first coding tool with a further value for the parameter different from the value.

13. The method of claim 12, wherein the further value is indicated in the bitstream.

14. The method of claim 1, wherein the plurality of components of the visual data are processed at least partially separately.

15. The method of claim 1, wherein the visual data comprise a video, a picture of the video, or an image.

16. The method of claim 1, wherein the conversion includes encoding the visual data into the bitstream.

17. The method of claim 1, wherein the conversion includes decoding the visual data from the bitstream.

18. An apparatus for visual data processing comprising a processor and a non-transitory memory with instructions thereon, wherein the instructions upon execution by the processor, cause the processor to perform acts comprising:
performing a conversion between visual data and a bitstream of the visual data with a neural network (NN)-based model, wherein the bitstream comprises a first indication indicating whether a value for a parameter for the NN-based model is common to processing of a plurality of components of the visual data.

19. A non-transitory computer-readable storage medium storing instructions that cause a processor to perform acts comprising:
performing a conversion between visual data and a bitstream of the visual data with a neural network (NN)-based model, wherein the bitstream comprises a first indication indicating whether a value for a parameter for the NN-based model is common to processing of a plurality of components of the visual data.

20. A non-transitory computer-readable recording medium storing a bitstream of visual data which is generated by a method performed by an apparatus for visual data processing, wherein the method comprises:
performing a conversion between the visual data and the bitstream with a neural network (NN)-based model, wherein the bitstream comprises a first indication indicating whether a value for a parameter for the NN-based model is common to processing of a plurality of components of the visual data.
